(19) United States
(12) Patent Application Publication
(10) Pub. No.: US 2026/0087811 A1
(43) Pub. Date: Mar. 26, 2026

(54) VIDEO SUMMARY SYSTEM CAPABLE OF DETECTING SPECIFIC OBJECT THROUGH TEXT

(71) Applicant: ZIOVISION CO., LTD., Chuncheon-si, Gangwon-do (KR)

(72) Inventors: Yoon KIM, Chuncheon-si, Gangwon-do (KR); Hyunsoo CHOI, Chuncheon-si, Gangwon-do (KR); Dohyeon KIM, Chuncheon-si, Gangwon-do (KR); Jongwoo HAN, Chuncheon-si, Gangwon-do (KR); Pooreum LEE, Chuncheon-si, Gangwon-do (KR); Heecheol KIM, Chuncheon-si, Gangwon-do (KR)

(21) Appl. No.: 18/288,934

(22) PCT Filed: Oct. 4, 2023
(86) PCT No.: PCT/KR2023/015234

§ 371 Date: Jun. 5, 2025

(30) Foreign Application Priority Data
Jul. 28, 2023 (KR) 10-2023-0098881

(51) Int. Cl. G06V 20/40; G06F 40/58; G06V 10/774

(52) U.S. Cl. CPC G06V 20/47; G06F 40/58; G06V 10/774; G06V 20/41

(57) ABSTRACT

The video summary system according to an embodiment of the present disclosure identifies objects by transforming text descriptions into text embedding vectors via a text encoder and images into image embedding vectors using an image encoder. By assessing the similarity between these vectors, users can input a description of an object or its actions to detect the said object. This approach mitigates the challenge of monitoring when the object count in the summarized video surpasses that of the original.

### TECHNICAL FIELD

The present disclosure relates to a video summary system capable of detecting a specific object through text.

### BACKGROUND

In modern society, a space is monitored using various video capture devices such as CCTV. However, replaying and analyzing a large amount of video data generated by these devices in real time and finding a necessary event requires a lot of manpower and time. In contrast, when a video is replayed quickly, an object is made to move too quickly, making it difficult to find the event. There is a trade-off relationship between real-time video replay and high-speed video replay. In order to solve this problem, a video summary technology has been proposed.

The video summary technology is a method of creating a video obtained by compressing an original video image into a short-form video. In this case, a matter of main concern in compression is the objects (people, animals, vehicles, etc.) in the original video. In this technology, frames in which dynamic objects appear from the original video are selected and the frames are combined to create a summary video. The (X, Y) coordinates of the dynamic objects are maintained as they are, so that a movement line of the object in the summary video reflects the reality as it is. Objects that appear at different times in the original video image may appear at the same time in the summary video.

This video summary technology caused another problem when detecting the event. In order to detect the event, an object should be identified or the action of the object should be identified. However, with the video summary technology, the number of objects that appear in the video at one point in time is significantly larger than that of the original video. In other words, it has become more difficult to identify the objects or their movements.

In order to solve this problem, a function to detect an object is needed. For example, a function that, when an operator inputs the text “a person carrying a child,” only “a person carrying a child” is shown in the summary video, other objects are excluded, and only the objects related to the event the operator want to found are exposed is needed.

Conventionally, there has been a technology for detecting objects from images through text. However, in the related art, the limitations of the technology were clear. When reviewing the prior art by taking an example of finding an image containing “a person kicking” by inputting “a person kicking” as text, it is as follows.

A method of searching for an image on Naver, Daum, etc. is not to detect an object, but to use a caption written by a content creator. This method cannot be used in a case an object in the video is not captioned as in the video summary technology.

Another method of detecting the object from the image is to use artificial intelligence. A model is built by collecting various photos of a “person kicking” and making the model learn the photos. When using the trained model, it is possible to find the “a person kicking” in the video. The problem is that it is needed to train the model for each action that needs to be found. In order to find “a person who cheer” and “a person who turn his/her head,” models that are respectively trained for the actions are needed. This method is also realistically impossible because there are so many different situations.

The present disclosure proposes a new method to solve this problem.

### SUMMARY

The present disclosure provides an image detection system that can find an object by converting text describing an image into a text embedding unit vector through a text encoder, converting the image into an image embedding unit vector through an image encoder, and calculating a similarity between the two vectors, and a video summary system using the same.

The present disclosure provides an image detection system with high performance even for Korean text and a video summary system using the same.

Meanwhile, other technical matters not specified in the present disclosure will be additionally considered within the scope that can be easily inferred from the detailed description below and effects thereof.

To implement the image detection system and the video summary system using the same, the following solutions are proposed.

In accordance with an exemplary embodiment of the present invention, a video summary system includes an object extraction module configured to detect an object in an original video and generate object information including a position and size in a frame of the object and an object ID, a compression module configured to generate a summary video by compressing the original video so that at least some of objects at different times in the original video are positioned at the same time, and an image detection module configured to detect an object corresponding to input text when a user inputs the text, in which the image detection module detects an object that needs to be found by converting the text describing an image into a text embedding unit vector through a text encoder, converting the image into an image embedding unit vector through an image encoder, and calculating a similarity between the text embedding unit vector and image embedding unit vector.

In the exemplary embodiment, the image detection module may be an artificial intelligence model trained with training data in which a caption is written on the image.

In this case, an English caption of the training data may be translated into a Korean caption using a large natural language generation model and added to the training data.

In this case, as a caption of the training data, a Korean caption or English caption with various expressions having the same or similar meaning may be generated using a large-scale natural language generation model (NLP) and added to the training data.

In this case, a pseudo-labeled image having an inappropriate caption may be added to the training data.

In the exemplary embodiment, when the image detection module detects an object that needs to be, in the summary video, an object positioned at the same time as the object detected in the original video may be exposed together.

In accordance with another exemplary embodiment of the present invention, an image detection system capable of detecting a specific object through text finds an object that needs to be found by converting text describing an image into a text embedding unit vector through a text encoder, converting the image into an image embedding unit vector through an image encoder, and calculating a similarity between the text embedding unit vector and image embedding unit vector.

In the other exemplary embodiment, the image detection module may be an artificial intelligence model trained with training data in which a caption is written on the image.

In the other exemplary embodiment, an English caption of the training data may be translated into a Korean caption using a large natural language generation model and added to the training data.

In the other exemplary embodiment, as a caption of the training data, a Korean caption or English caption with various expressions having the same or similar meaning may be generated using a large-scale natural language generation model and added to the training data.

In the other exemplary embodiment, a pseudo-labeled image with an inappropriate caption may be added to the training data.

### BRIEF DESCRIPTION OF THE DRAWINGS

Exemplary embodiments can be understood in more detail from the following description taken in conjunction with the accompanying drawings, in which:

FIG. 1 is a schematic configuration diagram of a video summary system in accordance with an exemplary embodiment of the present invention;

FIG. 2 is a screenshot of approximately three-hour-long original video;

FIG. 3 is a screenshot of approximately two-minute-long summary video compressed by a compression module;

FIG. 4 is a screenshot after filtering using a conventional method, with “male” and “female” as tags;

FIG. 5 is a schematic configuration diagram of an image detection module (system) of the video summary system in accordance with the exemplary embodiment of the present invention;

FIGS. 6 and 7 are screenshots when text is input into the image detection module;

FIG. 8 is an example of CoCo Captioning Data, which is public data used as training data; and

FIG. 9 is an example of Flickr30k, which is public data used as training data.

The accompanying drawings are intended as reference for understanding the technical idea of the present invention, and are not intended to limit the scope of the present invention.

### DETAILED DESCRIPTION OF EMBODIMENTS

Hereinafter, with reference to the drawings, the configuration of the present invention guided by various embodiments of the present invention and the effects resulting from the configuration will be described. In describing the present invention, if it is determined that related known functions may unnecessarily obscure the gist of the present invention as they are obvious to those skilled in the art, the detailed description thereof will be omitted.

The term “module” used in this document may include a unit implemented in hardware, software, or firmware, and may be used interchangeably with terms such as logic, logic block, component, or circuit, for example. The module may be an integrated part or a minimum unit of the part or a portion thereof that performs one or more functions.

In this document, the “module” or “node” uses a computing device such as a CPU, AP, etc. to perform tasks such as moving, storing, and converting data. For example, the “module” or “node” may be implemented as a device such as a server, PC, tablet PC, smartphone, etc.

In this document, a “deep learning model” means a model obtained by constructing neurons by training a neural network, which is an algorithm modeled based on how the human brain operates, and is broadly interpreted in the sense widely used in the art to which the present invention belongs.

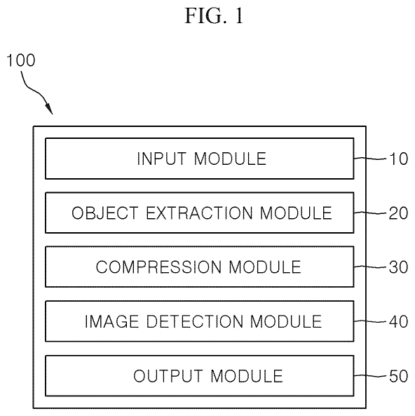

FIG. 1 is a schematic configuration diagram of a video summary system according to an embodiment of the present invention.

Referring to FIG. 1, the video summary system according to an embodiment of the present invention includes an input module 10, an object extraction module 20, an image detection module 40, and an output module 50.

Through the input module 10, the user inputs a command to control the system, describes an object that needs to be found, or inputs text describing an action of the object.

The object extraction module 20 detects the object in an original video and generates object information including a position and size of the object in a frame and an object ID.

When the object extraction module 20 receives the original video, the object extraction module 20 detects and segments a dynamic object from each frame of the original video, and detects object information for the segmented object. The object information includes coordinates (x, y) within the frame, width and height, and classification of objects such as people, animals, and vehicles. The object information is preset and may include a color, a direction of movement (left to right, etc.), etc. The operation described above is performed in every frame where a dynamic object appears. When the segmentation and detection of the object is completed, the identity of the object appearing across multiple frames is determined, and if it is determined to be the same object, the same ID is assigned. Since objects have continuity of movement, it is possible to determine whether or not objects that appear across multiple shots are identical by using frames in which the dynamic objects appear or using object information together. As described above, a process of segmenting the dynamic objects (segmentation), a process of detecting objects and generating object information (detecting), and a process of determining identity and assigning IDs to each object (tracking) are widely used techniques in an image processing field such as intelligent CCTV, and thus, detailed description thereof will be omitted.

The compression module 30 generates a summary video by compressing the original video so that at least some of the objects at different times in the original video are positioned at the same time. Objects at different times in the original video include a case where the objects are never positioned in the same frame at the same time, and a case where only some of the objects are positioned in the same frame at the same time. Furthermore, the objects at different times in the original video also includes a case where when there is object A, which has a long appearance time, and object B, which has a short appearance time and appears and disappears during the appearance of object A, the appearance time of object B is different from that of the original video with the the appearance time of object A as a reference.

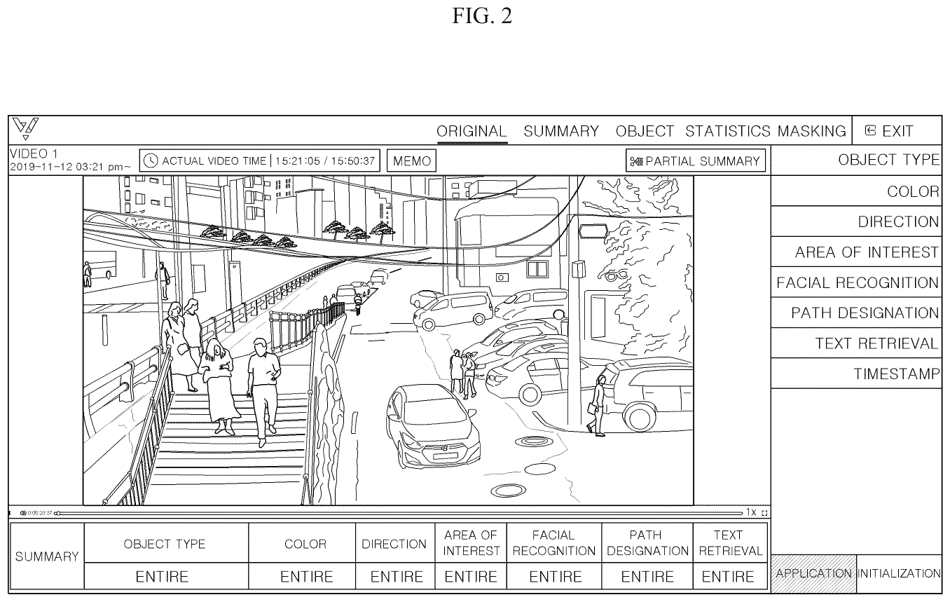

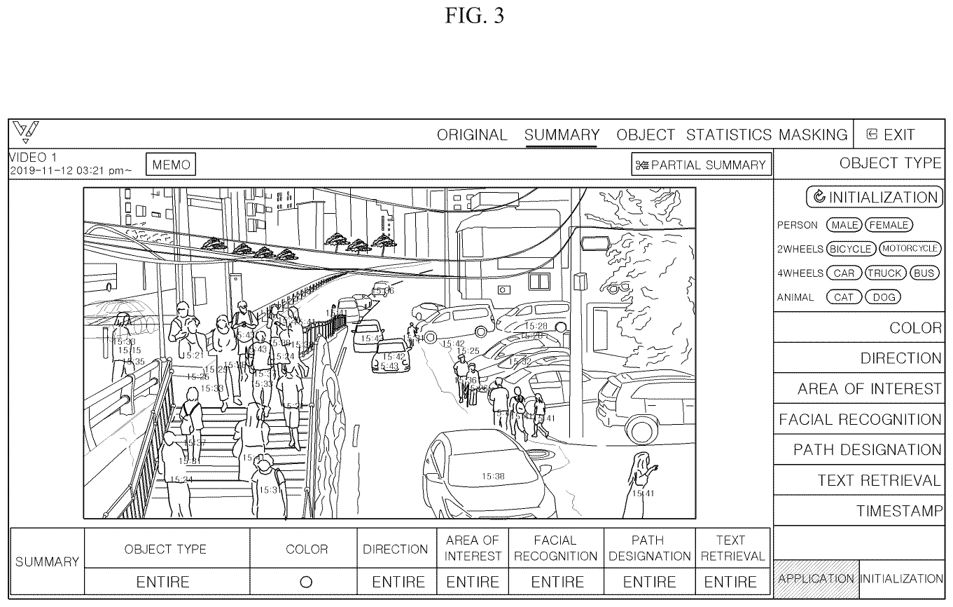

FIG. 2 is a screenshot of approximately three-hour-long original video, and FIG. 3 is a screenshot of approximately two-minute-long summary video compressed by a compression module. When comparing FIGS. 2 and 3, it can be seen that various objects (people, cars, etc.) that were positioned at different times in the original video are positioned in one screen. However, the problem is that there are too many objects that appear at one point in time in the summary video, and thus they cannot be monitored properly.

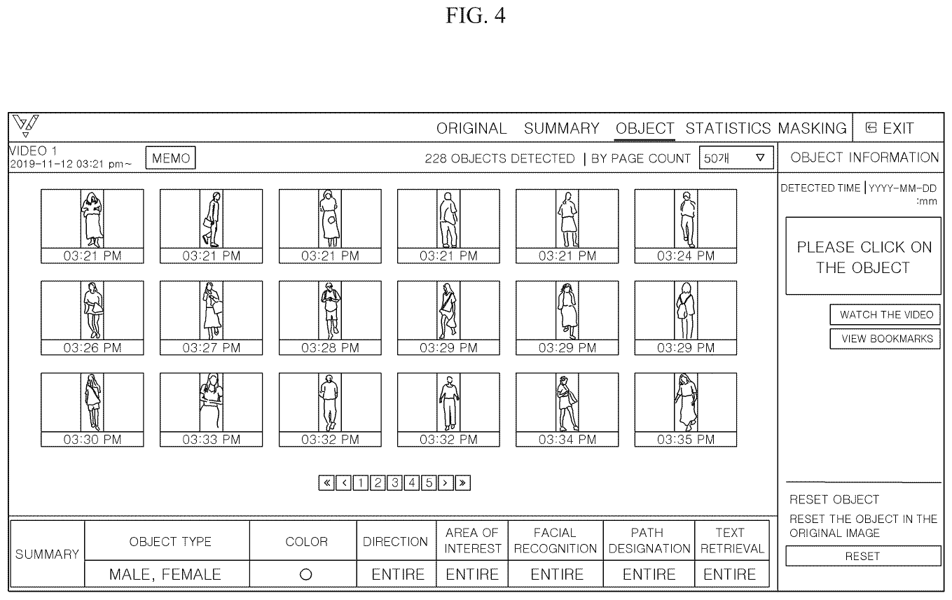

FIG. 4 is a screenshot after filtering using the conventional method, with “male” and “female” as tags. As shown in FIG. 4, when “male” and “female” are used as tags, too many objects are still output, and above all, there is a problem of not being able to find an object having a certain action or appearance.

In order to solve this problem, the present invention uses an image detection module (system) 40.

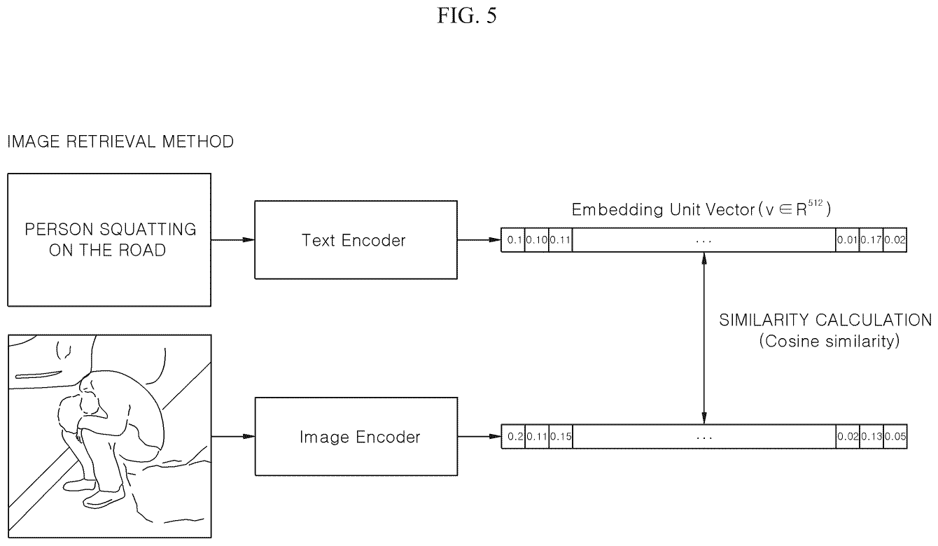

FIG. 5 is a schematic configuration diagram of an image detection module (system) of the video summary system according to an embodiment of the present invention.

The image detection module (system) (“system” is omitted in the description below) 40 detects an object corresponding to input text when the user inputs the text. To this end, the image detection module 40 detects the object that needs to be found by converting text describing an image into a text embedding unit vector through a text encoder, converting the image into an image embedding unit vector through an image encoder, and calculating a similarity between the text embedding unit vector and the image embedding unit vector.

The image detection module performs a function of finding the object related to text in the image when the user inputs the text.

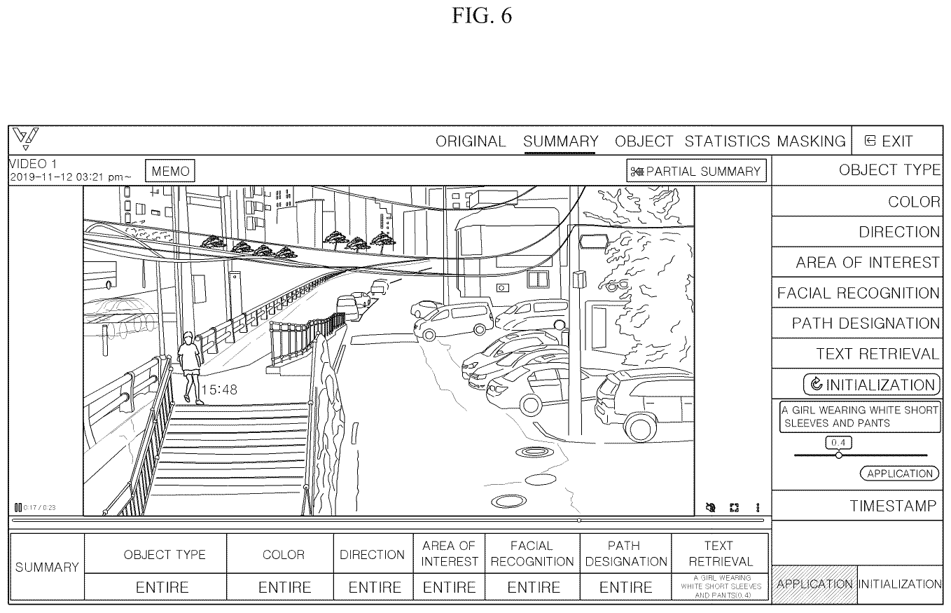

For example, if the user inputs text “a girl wearing white short sleeves and shorts”, as shown in FIG. 6, it can be seen that the image detection module 40 detects the image of “a girl wearing white short sleeves and shorts” in the summary video.

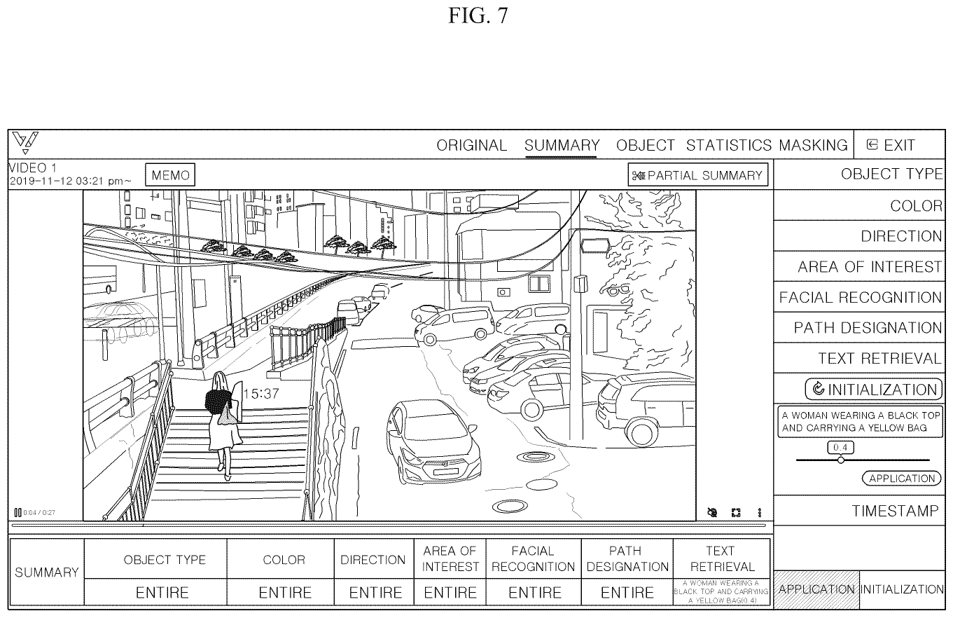

Similarly, if the user inputs text “a woman wearing a black top and carrying a yellow bag”, as shown in FIG. 7, the image detection module 40 detects the image of “a woman wearing a black top and carrying a yellow bag” in the summary video.

In order to perform the function of finding the object, the image detection module 40 goes through two main steps. The first step is the embedding of text and image, and the second step is the calculation of similarity between the embedding vectors.

First, the input text is converted into a form called a text embedding unit vector through the text encoder. The text encoder serves to convert text data into a low-dimensional (e.g., approximately 512-dimensional, etc.) real number vector. In the same way, the image is converted into an image embedding unit vector through the image encoder. The image encoder serves to convert the image into a low-dimensional (e.g., approximately 512-dimensional, etc.) vector form. The converted vectors represent the main characteristics of the text or image, which allow the text and image to be compared or analyzed.

The similarity between the converted text embedding unit vector and the image embedding unit vector can be calculated through a similarity calculation method such as cosine similarity. As for the similarity calculation method, other methods other than cosine similarity may be used. Similarity is a method of measuring how similar two vectors are pointing in the same direction, which allows the user to know how much a specific text is related to a specific image. More specifically, the similarity between the image and the text is calculated, and an image having a value higher than a threshold value is output as a detection result.

For this operation, the image detection module 40 uses an artificial intelligence model trained with training data in which a caption is written on an image. When using a pair of caption and image, the model learns information of the caption that describes the content of the image and understands the relevance between the image and the text.

More specifically, in the present invention, the text encoder and/or then image encoder is built through learning. The text encoder learns how to convert the caption (text) into an embedding vector, and the image encoder learns how to convert the image into an embedding vector. The encoders trained in this way then serves to convert new text or image into an embedding vector when they are given.

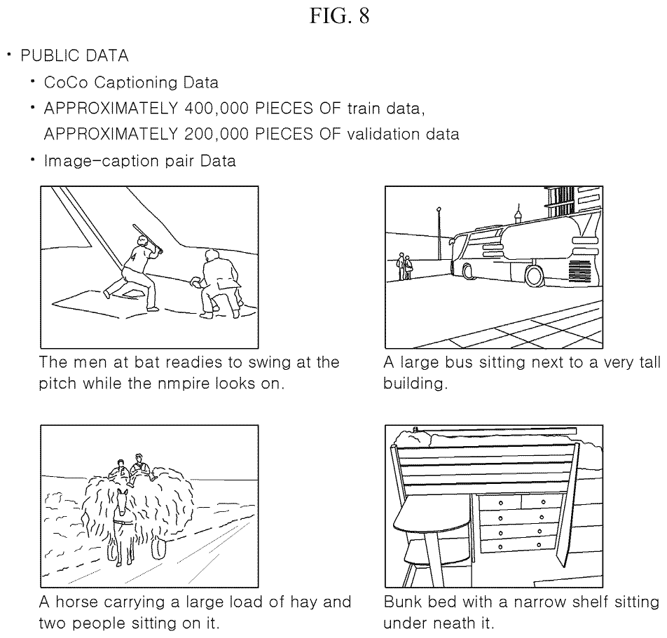

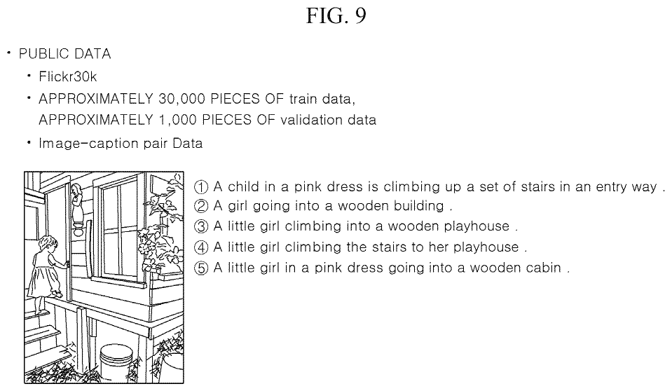

FIG. 8 is an example of CoCo Captioning Data, which is public data used as training data, and FIG. 9 is an example of Flickr30k, which is public data used as training data.

CoCo Captioning Data consists of approximately 400,000 pieces of train data and approximately 200,000 pieces of validation data, and is Image-caption pair data. Flickr30k consists of approximately 30,000 pieces of train data and approximately 1,000 pieces of validation data, and is Image-caption pair data.

Pseudo labeled data may be used as training data. Pseudo labeled data refers to data used by replacing unlabeled data with labels in predictions using a model. When some pseudo labeled data is included in training data, the object detection performance of the image detection module 40 is improved. In order to generate pseudo labeled data, captions were created from approximately 5 million images using Captioning Mode, which generates captions from images without captions, and the generated pseudo labeled data was added to the training data.

Meanwhile, the image detection module of the video summary system according to an embodiment of the present invention uses an artificial intelligence model trained with training data that contains captions described on images, and most of the captions in the current training data are in English. In this way, there is a problem that the artificial intelligence model does not work properly for Korean when training the artificial intelligence model with only the training data of the English caption. There have been attempts to generate the Korean caption using a translator in order to solve this problem, but there is still a problem of low performance for Korean text. The video summary system according to an embodiment of the present invention translates the English caption into the Korean caption using a large natural language model, and adds the image having Korean caption as training data. Although the translator is different from the language actually used by people, the large natural language model is similar to the language actually used by people. Therefore, when the image having the Korean caption generated using the large natural language model are added as training data, image detection performance using Korean text improves compared to when a translator is used. For reference, large natural language models include Generative Pretrained Transformer (GPT), Bidirectional Encoder Representations from Transformers (BERT), Google's BARD, and Text-to-Text Transfer Transformer (T5). Here, GPT and T5 were used. However, new large natural language models are currently being released, and the present invention will not be limited to a specific type of large natural language model.

Further, the image detection module of the video summary system according to an embodiment of the present invention uses an artificial intelligence model trained with training data containing the captions written on images, and uses a large natural language generation model to generate Korean or English captions with various expressions having the same or similar meaning, as the captions of training data, and adds the Korean or English captions to the training data, thereby significantly improving image detection performance by text.

As described above, as for the training of the artificial intelligence model both the text encoder and the image encoder should be trained. Training of the encoder was conducted using contrastive loss between image and caption. Contrast loss refers to a method of placing a text embedding unit vector in a row or column, placing an image embedding unit vector in a column or row, and then training pair data (the central diagonal portion of the resulting matrix) of the text embedding unit vector and the image embedding unit vector to be 1. Therefore, even when detecting an image, an image with cosine similarity between the text embedding unit vector and the image embedding unit vector close to approximately 1 is output as a result for the input text.

In addition, the present invention used both contrast loss and image-to-text matching loss to improve performance. In the image-to-text matching loss, the loss is calculated by performing binary classification of the image and text through a cross attention model. The cross-attention model is a technique that helps to analyze and understand the complex relationships between images and text, which measures how much a particular part of the image is related to a particular part of the text. Through this process, artificial intelligence eventually divides the relationship between images and text into binary classification. That is, if a given image and text are related to each other, they are classified as “1”, otherwise they are classified as “0”. Finally, the loss is calculated. Loss is a number that indicates how much the artificial intelligence prediction differs from an actual result. The smaller the loss, the better the artificial intelligence matches images and text. Conversely, the greater the loss, the more often the prediction of the artificial intelligence is wrong. Therefore, training is performed so as to minimize the loss.

In the present invention, training started from the text encoder by freezing a pre-trained image encoder.

Meanwhile, as a result of research conducted with financial support from the government (Ministry of Science and ICT), an image detection model called VL-KE-T5 is being released along with the code.

VL-KE-T5 used public data as training data as shown in Table 1 below, and Google's translation API was used for translation.

TABLE 1

| | | | | |
|---|---|---|---|---|
| CC 3M | COCO | SBU | Visual Genome | WIT |

English

| | | | | |
|---|---|---|---|---|
| 2,862,265 | 414,113 | 772,438 | 4,322,358 | 3,265,279 |

Korean (Translated)

| | | | | |
|---|---|---|---|---|
| 2,862,264 | 414,113 | 772,438 | 4,322,358 | 3,265,273 |

Korean
WIT
54,956

In addition, VL-KE-T5 used google/vit-base-patch16-384 as an image encoder and KETI-AJR/ke-t5-base as a text encoder. A larger model was used compared to the present invention.

The performance of VL-KE-T5 and the image detection modules of the present invention was compared.

The results of testing with approximately 1000 pieces of Coco validation data are as follows. Table 2 below compares the performance of KETI's VL-KE-T5 and the image detection module of the present invention.

TABLE 2

| | Text | Image | | Training data | | |
|---|---|---|---|---|---|---|
| | Encoder | Encoder | Translator | Number of types | Performance | [symbol] |
| Embodiment | Transformer | ViT- | GPT 3.5, | CoCo, Flickr/ | R@1: 0.356 | FPS: |
| 1(contrastive | Encoder | B/32, | Finetuned | approximately 5 | R@5: 0.715 | 1600 |
| loss) | | 224 | nllb model | million pieces | | |
| | | | | of data | | |
| Embodiment | Transformer | ViT- | GPT 3.5, | CoCo, Flickr/ | R@1: 0.402 | FPS: |
| 2(contrastive | Encoder | B/32, | Finetuned | approximately 5 | R@5: 0.792 | 1600 |
| loss) | | 224 | nllb model | million pieces | | |
| | | | | of training | | |
| | | | | data generation | | |
| | | | | by NLP | | |
| Embodiment | Transformer | ViT- | GPT 3.5, | CoCo, Flickr/ | R@1: 0.497 | FPS: |
| 3(contrastive | Encoder | B/32, | Finetuned | approximately 5 | R@5: 0.805 | 1600 |
| loss) | | 224 | nllb model | million pieces | | |
| | | | | of training | | |
| | | | | data generation | | |
| | | | | by NLP pseudo | | |
| | | | | labeled image | | |
| Embodiment | Transformer | ViT- | GPT 3.5, | CoCo, Flickr/ | R@1: 0.678 | FPS: |
| 4(contrastive | Encoder | B/32, | Finetuned | approximately 5 | R@5: 0.922 | 1600 |
| loss + image | | 224 | nllb model | million pieces | | |
| text matching | | | | of training | | |
| loss) | | | | data generation | | |
| | | | | by NLP | | |
| Embodiment | Transformer | ViT- | GPT 3.5, | CoCo, Flickr/ | R@1: 0.731 | FPS: |
| 5(contrastive | Encoder | B/32, | Finetuned | approximately 5 | R@5: 0.939 | 1600 |
| loss + image | | 224 | nllb model | million pieces | | |
| text matching | | | | of training | | |
| loss) | | | | data generation | | |
| | | | | by NLP pseudo | | |
| | | | | labeled image | | |
| Comparative | Pretrained | ViT- | Google API | CC3M, CoCo, SBU, | R@1: 0.335 | FPS: |
| example | T5 Model | B/16, | | Visual Genome, | R@5: 0.699 | 100 |
| | | 384 | | WIT/approximately | | |
| | | | | 9 million images | | |

Here, Recall@5 means that there is a correct answer among approximately 5 images, and means that the performance was evaluated based on approximately 5 images because a person can easily find the desired object when approximately 5 objects are displayed during video monitoring.

When the image detection module 40 detects the object that needs to be found, the result is output to the user through the output module 50. When the image detection module detects the object that needs to be found, in the summary video, an object positioned at the same time as the object detected in the original video is exposed together and the relevance between objects can be checked.

The video summary system and/or object detection system as described above may be implemented as a program (or application) containing an executable algorithm that can be executed on a computer. The program may be provided by being stored in a non-transitory computer readable medium. Here, the non-transitory readable medium refers to a medium that stores data semi-permanently and may be read by a device, rather than a medium that stores data for a short period of time, such as a register, a cache, and a memory. Specifically, the various applications or programs described above may be provided by being stored in the non-transitory readable media such as CD, DVD, hard disk, Blu-ray disk, USB, memory card, ROM, etc.

The scope of protection of the present invention is not limited to the description and expression of the embodiments explicitly described above. In addition, it is once again added that the scope of protection of the present invention may not be limited due to changes or substitutions that are obvious in the technical field to which the present invention pertains.

The video summary system according to an embodiment of the present disclosure can find an object by converting text describing an image into a text embedding unit vector through a text encoder, converting the image into an image embedding unit vector through an image encoder, and calculating a similarity between the text embedding unit vector and image embedding unit vector. Accordingly, when using the video summary system according to an embodiment of the present disclosure, a user can input a description of an object or an action that the object is performing as text and detect the object corresponding to the description or the object performing the action. Therefore, when using the video summary system according to an embodiment of the present disclosure, it is possible to solve the problem that monitoring becomes difficult because the number of objects appearing in the summary video increases compared to that of the original video.

In addition, the image detection module of the video summary system according to an embodiment of the present invention uses an artificial intelligence model trained with training the caption is written on the image, and most of the captions in the current training data are in English. In this way, there is a problem that the artificial intelligence model does not work properly for Korean when training the artificial intelligence model only with training data having the English caption. In order to solve this problem, there has been an attempt to generate the Korean caption using a translator, but there is still a problem of low performance for Korean text. The video summary system according to an embodiment of the present disclosure translates an English caption into a Korean caption using a large natural language model, and adds an image having the Korean caption as training data. Although the translator is different from the language actually used by people, the large natural language model is similar to the language actually used by people, and thus when the image having the Korean caption generated using the large natural language model is added as training data, the image detection performance using Korean text improves compared to when the translator is used.

In addition, the image detection module of the video summary system according to an embodiment of the present invention uses an artificial intelligence model trained with training data in which the caption is written on the image. Image detection performance by text is significantly improved by generating, as the caption for training data, the Korean or English caption with various expressions having the same or similar meaning using a large natural language generation model and adding the Korean or English captions to the training data.

On the other hand, it is to be added that even if the effects are not explicitly mentioned herein, the effects described in the following specification and their potential effects expected by the technical features of the present invention are treated as if they were described in the specification of the present invention.

Although the video summary system capable of detecting a specific object through text has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A video summary system, comprising:
an object extraction module configured to detect an object in an original video and generate object information including a position and size in a frame of the object and an object ID;
a compression module configured to generate a summary video by compressing the original video so that at least some of objects at different times in the original video are positioned at the same time; and
an image detection module configured to detect an object corresponding to input text when a user inputs the text,
wherein the image detection module detects an object that needs to be found by converting the text describing an image into a text embedding unit vector through a text encoder, converting the image into an image embedding unit vector through an image encoder, and calculating a similarity between the text embedding unit vector and image embedding unit vector.

2. The video summary system of claim 1, wherein
the image detection module is an artificial intelligence model trained with training data in which a caption is written on the image.

3. The video summary system of claim 2, wherein
an English caption of the training data may be translated into a Korean caption using a large natural language generation model and added to the training data.

4. The video summary system of claim 2, wherein
as a caption of the training data, a Korean caption or English caption with various expressions having the same or similar meaning is generated using a large-scale natural language generation model (NLP) and added to the training data.

5. The video summary system of claim 2, wherein
a pseudo-labeled image having an inappropriate caption is added to the training data.

6. The video summary system of claim 1, wherein
when the image detection module detects an object that needs to be found, an object positioned at the same time as the object detected in the original video is exposed together on the summary video.
